(19) United States
(12) Patent Application Publication
(10) Pub. No.: US 2012/0000543 A1
(43) Pub. Date: Jan. 5, 2012

(54) METHOD AND DEVICE FOR ACTIVELY SUPPRESSING PRESSURE OSCILLATIONS IN A HYDRAULIC SYSTEM

(76) Inventors: Georg Keintzel, Steyregg (AT); Anton Pirko, Wien (AT)

(21) Appl. No.: 13/132,715

(22) PCT Filed: Nov. 30, 2009
(86) PCT No.: PCT/EP2009/066014

§ 371 Date: Sep. 21, 2011

(30) Foreign Application Priority Data
Dec. 5, 2008 (AT) A1897/2008

(51) Int. Cl. F17D 3/00; F16L 55/04

(52) U.S. Cl. 137/12; 138/30

(57) ABSTRACT

In a method and a device for actively suppressing pressure oscillations or pressure pulses in a hydraulic system of a cold or warm roll train or a strip treatment installation, the following method steps are carried out: a) detection of a pressure signal by means of a pressure sensor by permanent measurement of a pressure in the hydraulic system; b) determination of an alternating component of the pressure signal; c) determination of at least one temporally changing actuating variable in real time with the aid of a regulator, taking at least one setpoint value and the alternating component into consideration; d) loading of at least one actuator with the actuating variable, the actuator changing a volume which corresponds to the actuating variable and is connected to the hydraulic system, as a result of which the pressure oscillations in the hydraulic system are suppressed.

### CROSS-REFERENCE TO RELATED APPLICATIONS

This application is a U.S. National Stage Application of International Application No. PCT/EP2009/066014 filed Nov. 30, 2009, which designates the United States of America, and claims priority to Austrian Application No. A1897/2008 filed Dec. 5, 2008, the contents of which are hereby incorporated by reference in their entirety.

### TECHNICAL FIELD

The present invention relates to a method and to a device for actively suppressing pressure oscillations or pressure pulses in a hydraulic system of a cold or warm roll train or a strip treatment installation for iron, steel or aluminum materials.

### BACKGROUND

It is known that periodically occurring pressure fluctuations or aperiodical pressure pulses in hydraulic systems cause different problems, for example excessive noise development, reduction in the service life of components, disruption of regulating circuits, etc. Pressure oscillations or pulses can either be caused internally in the hydraulic system, for example as a result of the nonuniformity of the delivery quantity of pumps or as a result of the actuation of valves, etc., but can also be caused externally, for example as a result of periodic load fluctuations in hydraulic cylinders or motors. Furthermore, it is known that excessive pressure oscillations can occur in the hydraulic system, in particular in the case of hydraulic systems with high dynamics, for example comprising a continuous hydraulic valve (for example, an electrically actuated proportional valve or servovalve) and a hydraulic cylinder or motor.

It has been shown that excessive pressure oscillations can also occur in the hydraulic systems of modern roll trains or strip treatment installations, for example during the hydraulic roll engagement, which excessive pressure oscillations can lead to a reduction in the service life of components, but also to considerable damage of the stands of a roll train and/or to defects of the rolling stock. Above all, this is due to the fact that hydraulic systems which react faster and faster (higher dynamics) are used on one side, as a result of higher rolling forces or rolling speeds, and on the other hand, as a result of higher requirements of the reaction time and economy, the damping in the hydraulic systems (for example, the viscous damping in the seals of cylinders) is reduced.

DE 4 302 977 A1 has disclosed a device for actively suppressing pressure oscillations in a hydraulic assembly, which device has a pressure sensor, a regulating device with an associated amplifier, and a volume compensator. However, concrete instructions for the method to be carried out and more detailed indications for an advantageous application of the device in a hydraulic system of a roll mill or strip treatment installation cannot be gathered from the disclosure.

### SUMMARY

According to various embodiments, a method and a device for actively suppressing pressure oscillations or pressure pulses in a hydraulic system of a cold or warm roll train or a strip treatment installation can be provided, by way of which method and device pressure oscillations or pulses which occur can be suppressed particularly effectively by means of a simple and inexpensive device.

According to an embodiment, a method for actively suppressing pressure oscillations in a hydraulic system of a cold or warm roll train or a strip treatment installation for iron, steel or aluminum materials, may comprise the following method steps in the stated sequence: a) detection of a pressure signal by means of a pressure sensor by permanent measurement of a pressure in the hydraulic system; b) determination of an alternating component of the pressure signal; c) determination of at least one temporally changing actuating variable in real time with the aid of a regulator, taking at least one setpoint value and the alternating component into consideration; d) loading of at least one actuator with the actuating variable, the actuator changing a volume which corresponds to the actuating variable and is connected to the hydraulic system, as a result of which the pressure oscillations in the hydraulic system are suppressed.

According to a further embodiment, the alternating component can be subjected to either highpass or bandpass filtering. According to a further embodiment, the regulator may use the setpoint value zero during the determination of the actuating variable. According to a further embodiment, the temporally changing actuating variable can be fed to a lead/lag element and in the process the phase relation is changed. According to a further embodiment, the temporally changing actuating variable can be fed to the actuator after amplification. According to a further embodiment, the method can be applied to a hydraulic system of an advancing cylinder of a rolling stand. According to a further embodiment, different frequency bands can be filtered out of the alternating component, said frequency bands are fed to at least one regulator for determining temporally changing actuating variables, and the actuating variables are fed to at least one actuator which changes a volume which corresponds to the actuating variable and is connected to the hydraulic system, as a result of which the pressure oscillations in the hydraulic system are suppressed.

According to another embodiment, a device for actively suppressing pressure oscillations in a hydraulic system of a cold or warm roll train or a strip treatment installation for iron, steel or aluminum materials, may have at least one pressure sensor which is connected to the hydraulic system for detecting a pressure signal, an element for determining an alternating component of the pressure signal, to which element the pressure signal can be fed, at least one regulating device, to which the alternating component and a setpoint value can be fed and with the aid of which at least one actuating variable can be determined, and at least one actuator which is connected to the hydraulic system and has a variable volume, to which actuator the actuating variable can be fed.

According to a further embodiment of the device, the actuator can be configured as a piezoelectric or magnetostrictive actuator. According to a further embodiment of the device, an actuator can be equipped with a pressure sensor for detecting a pressure signal. According to a further embodiment of the device, a pressure sensor can be situated in an actuator which is configured as a hollow cylinder. According to a further embodiment of the device, the device can be connected to a hydraulic valve and a hydraulic cylinder of an advancing means of a rolling stand of a roll train.

According to yet another embodiment the method as described above or the device as described above can be used in the processing and/or production of metallic materials, in particular in a combined casting and rolling installation.

According to a further embodiment of the use of the method or device, the combined casting and rolling installation can be a thin strip casting installation or a thin slab casting installation (ESP).

### BRIEF DESCRIPTION OF THE DRAWINGS

Further advantages and features result from the following description of non-restrictive exemplary embodiments, reference being made to the following figures which show the following:

FIG. 1 shows a diagram of a control system for actively suppressing pressure oscillations in a hydraulic system of a roll train,

FIG. 2 shows a diagram of a device according to various embodiments for suppressing pressure oscillations in a hydraulic system of a roll train, and

FIGS. 3 and 4 show diagrams of an actuator with an integrated measuring device.

### DETAILED DESCRIPTION

In the following text, no distinction will be made any longer between periodically occurring pressure oscillations and aperiodically occurring pressure pulses; both oscillation types are called pressure oscillations overall.

According to various embodiments, a method of the type mentioned in the introduction, may comprise the following method steps which are carried out in the stated sequence:

a) detection of a pressure signal by means of a pressure sensor by permanent measurement of a pressure in the hydraulic system;
b) determination of an alternating component of the pressure signal;
c) determination of at least one temporally changing actuating variable in real time with the aid of a regulator, taking at least one setpoint value and the alternating component into consideration;
d) loading of at least one actuator with the actuating variable, the actuator changing a volume which corresponds to the actuating variable and is connected to the hydraulic system, as a result of which the pressure oscillations in the hydraulic system are suppressed.

Here, a pressure signal is detected by means of a pressure sensor (for example, by way of a piezoelectric, piezoresistive or strain gauge measuring cell) by permanent measurement of a pressure in a hydraulic system of a cold or warm roll mill or a strip treatment installation for iron, steel or aluminum materials. A hydraulic system is understood as meaning a section (typically a hydraulic circuit or a hydraulic axle) of a hydraulic assembly which is hydraulically connected to one another, for example the region between a hydraulic valve and a hydraulic cylinder including the hydraulic lines and hoses. Subsequently, an alternating component is determined from the pressure signal, that is to say the constant component of the pressure signal is removed, and is fed to a regulator. The determination of the alternating component can either take place by way of an electronic filter module or by way of a digital filter (for example, removal of the constant component by means of an observation window (“sliding window”), comprising n measured values of the pressure signal (filter arrangement n); it goes without saying, however, that the removal of the DC component can also take place as late as in the algorithm of the regulator); as an alternative, the determination of the alternating component can also take place by means of a piezoelectric pressure sensor and a charge amplifier which is either connected behind the pressure sensor or is integrated into the pressure sensor. Taking at least one setpoint value and the alternating component of the pressure signal into consideration, the regulator determines at least one temporally changing actuating variable which is used to load at least one actuator with a variable volume. As a result of the loading with the actuating variable, the actuator releases a volume which corresponds to the actuating variable. In other words, the volume of the hydraulic system is changed via the actuator, as a result of which the volumetric flow oscillation which accompanies the pressure oscillation is compensated for at least partially and, as a consequence, the pressure oscillation is also suppressed. An actuating variable of zero can correspond, for example, to a middle volume, that is to say a neutral or undeflected position of the actuator; it goes without saying, however, that it is also possible that an actuating variable of zero corresponds to a minimum volume; a maximum actuating variable can then be associated, for example, with a maximum volume. The transmission of the actuating variable signal from the regulator to the actuator can take place via cable or wirelessly (for example, via radio).

It is advantageous for the alternating component to be subjected to either highpass or bandpass filtering. By means of highpass filtering, the targeted decoupling of the suppression of pressure oscillations is possible from further regulating circuits which are optionally present in the system, for example position or force regulation of a hydraulic cylinder. Bandpass filtering makes targeted suppression of defined frequency ranges of the pressure oscillations possible (which coincide, for example, with a natural frequency of the rolling stand or a subsystem or have a high amplitude or intensity); it goes without saying that the use of adaptive bandpass filters (which, for example, automatically isolate a frequency range with a high amplitude) is possible.

If complete extinction of the pressure oscillations which occur is desired, the regulator uses the setpoint value zero during the determination of the actuating variable.

Since each real actuator has a phase shift in the transmission response, it is possible to feed the temporally changing actuating variable to a lead/lag element and in the process to change the phase relation in a targeted manner. If, for example, the frequency response of an actuator trails at a defined frequency f by 30°, the phase shift of the actuator at f can be compensated for completely by means of a lead element which has a phase shift of 30° at f.

A further embodiment of the method comprises the fact that the temporally changing actuating variable is fed to the actuator after amplification. As a result, it is possible to separate the signal processing part in the regulator from the power part, as a result of which high power outputs can be connected at the actuator with high regulating accuracy.

Since the pressure oscillations in hydraulic systems of the advancing cylinders have a direct influence on the quality of the rolling stock and are therefore particularly disruptive, it is advantageous to apply the method according to various embodiments to a hydraulic system of an advancing cylinder of a rolling stand.

A further embodiment comprises filtering different frequency bands out of the alternating component, feeding said frequency bands to at least one regulator for determining temporally changing actuating variables, then feeding the actuating variables to at least one actuator which changes a volume which corresponds to the actuating variable and is connected to the hydraulic system, as a result of which the pressure oscillations in the hydraulic system are suppressed. As a result, it is possible not only to suppress a frequency component of the pressure oscillations, but also to suppress a plurality of frequency components at the same time, for example integral harmonics of a basic oscillation.

In order to make as direct as possible an implementation of the method according to various embodiments possible, it is advantageous that the device has the following: at least one pressure sensor which is connected to the hydraulic system for detecting a pressure signal, an element for determining an alternating component of the pressure signal, to which element the pressure signal can be fed, at least one regulating device, to which the alternating component and a setpoint value can be fed and with the aid of which at least one actuating variable can be determined, and at least one actuator which is connected to the hydraulic system and has a variable volume, to which actuator the actuating variable can be fed.

Particularly robust and highly dynamic actuators which can additionally also still apply high forces can be achieved if the actuator is configured as a piezoelectric or magnetostrictive actuator. Piezoelectric actuators are familiar to a person skilled in the art; magnetostrictive actuators, such as actuators made from the material Terfenol-D® from the Etrema company, have excellent dynamic properties and can likewise be used advantageously.

In a further embodiment of the device, an actuator is equipped with a pressure sensor for detecting a pressure signal. In one embodiment, a pressure sensor is situated in an actuator which is configured as a hollow cylinder. These special arrangements provide compact structural units comprising an actuator and pressure sensor which have to be connected electrically only once.

According to an embodiment, the device can be integrated into a hydraulic system of a rolling installation, at least comprising a hydraulic valve, a hydraulic cylinder and a hydraulic line or hose, if the device is connected to the hydraulic valve and the hydraulic cylinder of a roll advancing means of the rolling stand. The installation is particularly compact when the device is installed into an intermediate plate of the hydraulic valve.

The method or the device according to various embodiments can advantageously be used in combined casting and rolling installations, in particular in thin strip casting installations, very particularly preferably in two roll casting installations, or in thin slab casting installations of the ESP type (endless strip production).

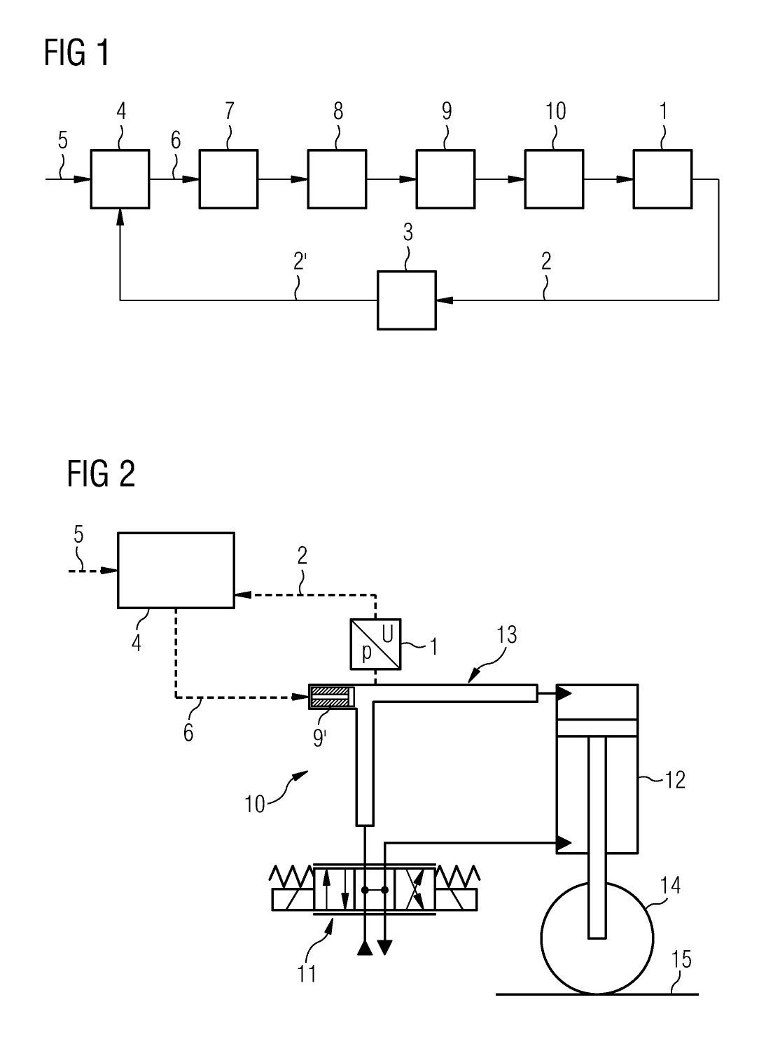

FIG. 1 shows the basic construction of a control system for suppressing pressure oscillations in a hydraulic system of a roll train. A pressure signal 2 is detected in a hydraulic system 10 via a pressure sensor 1, the pressure signal 2 is fed to a highpass filter 3 (for details of the electronic circuit, see, for example, page 35 of P. Horowitz, W. Hill, The Art of Electronics, Cambridge University Press, second edition, 1989) which determines the alternating component of the pressure signal 2′ and feeds it to a regulator 4. Said regulator 4 calculates a temporally changing actuating variable 6 in real time by means of a regulating law with consideration of the alternating component 2′ and a setpoint variable 5, which actuating variable 6 is fed to a lead/lag element 7. The phase relation of the actuating variable 6 is changed by the lead/lag element 7, as a result of which the phase shift of an actuator 9 is compensated for at least partially. Following the lead/lag element 7, the phase shifted actuating variable signal is amplified by means of an amplifier 8 with regard to the voltage amplitude and the current strength and is subsequently fed to the actuator 9. A volume which corresponds to the actuating variable and is connected to the hydraulic system 10 is changed by the actuator 9, which volume compensates at least partially for the volumetric flow oscillations which accompany the pressure oscillations, as a result of which the pressure oscillations are also compensated for.

FIG. 2 shows a diagrammatic device for suppressing pressure oscillations in a hydraulic system of a stand for rolling iron or steel materials. A pressure signal 2 is detected by means of a pressure sensor 1 by permanent measurement of a pressure in a hydraulic system 10 for advancing a roll 14 for rolling a rolling stock 15 comprising iron or steel materials, the hydraulic system comprising a hydraulic valve 11, a hydraulic cylinder 12 and a hydraulic line 13. Here, the pressure sensor can be situated either in the section between a piezoelectric actuator 9′ and the hydraulic cylinder 12 (as shown) or in the section between the hydraulic valve 11 and the actuator 9′. It goes without saying that it is also possible that a plurality of pressure sensors are arranged between the piezoelectric actuator 9′ and the hydraulic cylinder 12 or between the hydraulic valve 11 and the actuator 9. The pressure signal 2 is transmitted to a digital regulator which determines a frequency band of the alternating component and calculates a temporally changing actuating variable 6 with consideration of a setpoint value 5 and with the aid of a regulating algorithm. After amplification in an amplifier (not shown), the actuating variable is fed to the piezoelectric actuator 9′ which releases a volume which corresponds to the actuating variable 6 and is connected to the hydraulic line 13, with the result that the volumetric flow oscillations which accompany the pressure oscillations are compensated for at least partially, as a result of which the pressure oscillations are also compensated for.

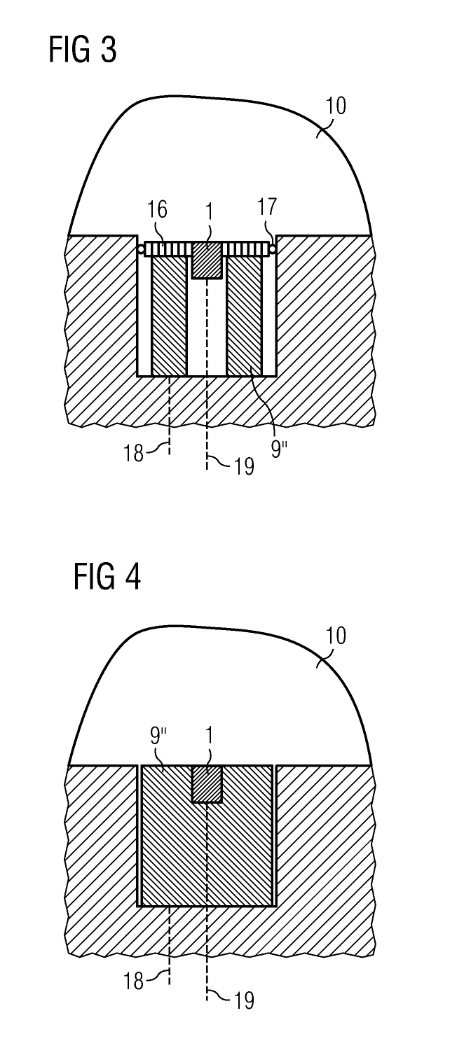

FIGS. 3 and 4 show diagrammatic illustrations of a magnetostrictive actuator 9″ with an integrated pressure sensor 1. In FIG. 3, the actuator 9″ is configured as a hollow cylinder, and the pressure sensor 1 is integrated into a cavity of the actuator 9″, which cavity is sealed with respect to a hydraulic system 10 by means of a piston 16, a seal 17 and a housing. In FIG. 4, the pressure sensor 1 is integrated into the actuator 9″, as a result of which the installation of the assembly, comprising the pressure sensor 1 and actuator 9″, is simplified further. In both FIGS. 3 and 4, the actuator 9″ is supplied via an electric line 18; an electric line 19 supplies the pressure sensor 1 and transmits the measured data to a filter or a regulator with an integrated filter.

It goes without saying that the method or the device according to various embodiments can be used in any desired hydraulic systems of mobile or industrial hydraulics.

### LIST OF DESIGNATIONS

1 Pressure sensor
2 Pressure signal
2′ Alternating component of the pressure signal
3 Bandpass filter
4 Regulator
5 Setpoint variable
6 Actuating variable
7 Lead/lag element
8 Amplifier
9 Actuator
9′ Piezoelectric actuator
9″ Magnetostrictive actuator
10 Hydraulic system
11 Hydraulic valve
12 Hydraulic cylinder
13 Hydraulic line
14 Roll
15 Rolling stock
16 Piston
17 Seal
18 Electric line
19 Electric line

What is claimed is:

1. A method for actively suppressing pressure oscillations in a hydraulic system of a cold or warm roll train or a strip treatment installation for iron, steel or aluminum materials, comprising the following method steps in the stated sequence:
a) detecting a pressure signal by means of a pressure sensor by permanent measurement of a pressure in the hydraulic system;
b) determining an alternating component of the pressure signal;
c) determining at least one temporally changing actuating variable in real time with the aid of a regulator, taking at least one setpoint value and the alternating component into consideration; and
d) loading of at least one actuator with the actuating variable, the actuator changing a volume which corresponds to the actuating variable and is connected to the hydraulic system, as a result of which the pressure oscillations in the hydraulic system are suppressed.

2. The method according to claim 1, wherein the alternating component is subjected to either highpass or bandpass filtering.

3. The method according to claim 1, wherein the regulator uses the setpoint value zero during the determination of the actuating variable.

4. The method according to claim 1, wherein the temporally changing actuating variable is fed to a lead/lag element and in the process the phase relation is changed.

5. The method according to claim 1, wherein the temporally changing actuating variable is fed to the actuator after amplification.

6. The method according to claim 1, wherein the method is applied to a hydraulic system of an advancing cylinder of a rolling stand.

7. The method according to claim 1, wherein different frequency bands are filtered out of the alternating component, said frequency bands are fed to at least one regulator for determining temporally changing actuating variables, and the actuating variables are fed to at least one actuator which changes a volume which corresponds to the actuating variable and is connected to the hydraulic system, as a result of which the pressure oscillations in the hydraulic system are suppressed.

8. A device for actively suppressing pressure oscillations in a hydraulic system of a cold or warm roll train or a strip treatment installation for iron, steel or aluminum materials, having at least one pressure sensor which is connected to the hydraulic system for detecting a pressure signal, an element for determining an alternating component of the pressure signal, to which element the pressure signal can be fed, at least one regulating device, to which the alternating component and a setpoint value can be fed and with the aid of which at least one actuating variable can be determined, and at least one actuator which is connected to the hydraulic system and has a variable volume, to which actuator the actuating variable can be fed.

9. The device according to claim 8, wherein the actuator is configured as a piezoelectric or magnetostrictive actuator.

10. The device according to claim 8, wherein an actuator is equipped with a pressure sensor for detecting a pressure signal.

11. The device according to claim 10, wherein a pressure sensor is situated in an actuator which is configured as a hollow cylinder.

12. The device according to claim 8, wherein the device is connected to a hydraulic valve and a hydraulic cylinder of an advancing means of a rolling stand of a roll train.

13. The method according to claim 1, wherein the method is used in at least one of the processing and production of metallic materials or in a combined casting and rolling installation.

14. The method according to claim 13, wherein the combined casting and rolling installation being a thin strip casting installation or a thin slab casting installation (ESP).

15. The method according to claim 13, wherein the alternating component is subjected to either highpass or bandpass filtering.

16. The method according to claim 13, wherein the regulator uses the setpoint value zero during the determination of the actuating variable.

17. The method according to claim 13, wherein the temporally changing actuating variable is fed to a lead/lag element and in the process the phase relation is changed.

18. The method according to claim 13, wherein the temporally changing actuating variable is fed to the actuator after amplification.

19. The method according to claim 13, wherein the method is applied to a hydraulic system of an advancing cylinder of a rolling stand.

20. The method according to claim 13, wherein different frequency bands are filtered out of the alternating component, said frequency bands are fed to at least one regulator for determining temporally changing actuating variables, and the actuating variables are fed to at least one actuator which changes a volume which corresponds to the actuating variable and is connected to the hydraulic system, as a result of which the pressure oscillations in the hydraulic system are suppressed.

21. A method for actively suppressing pressure oscillations in a hydraulic system of a cold or warm roll train or a strip treatment installation for iron, steel or aluminum materials, comprising the steps of:
providing a device having at least one pressure sensor which is connected to the hydraulic system for detecting a pressure signal, an element for determining an alternating component of the pressure signal, to which element the pressure signal can be fed, at least one regulating device, to which the alternating component and a setpoint value can be fed and with the aid of which at least one actuating variable can be determined, and at least one actuator which is connected to the hydraulic system and has a variable volume, to which actuator the actuating variable can be fed; and
using the device in at least one of the processing and production of metallic materials or in a combined casting and rolling installation.
